(19) United States
(12) Patent Application Publication
(10) Pub. No.: US 2026/0123664 A1
(43) Pub. Date: May 7, 2026

(54) AN APPRATUS FOR CUTTING A SHEET OF AEROSOL-GENERATING MATERIAL AND ADJUSTMENT METHOD THEREFOR

(71) Applicant: NICOVENTURES TRADING LIMITED, London (GB)

(72) Inventors: Daniel BRAY, London (GB); Jeong Hwan PARK, London (GB); Richard LEBBON, London (GB)

(21) Appl. No.: 19/120,334

(22) PCT Filed: Oct. 20, 2023
(86) PCT No.: PCT/GB2023/052742

§ 371 Date: Apr. 11, 2025

(30) Foreign Application Priority Data
Oct. 21, 2022 (GB) 2215642.6

(51) Int. Cl. A24C 5/18; B26D 1/22; B26D 1/24

(52) U.S. Cl. CPC A24C 5/1828; B26D 1/225; B26D 1/245

(57) ABSTRACT

An apparatus for cutting a sheet of aerosol generating material includes a first cutting element having a cutting edge and a second cutting element. The first cutting element is rotatable about its central axis and the second cutting element that is rotatable about its central axis. The central axis of the first cutting element and the central axis of the second cutting element are spaced apart by an initial pre-defined distance. The first and second cutting elements are configured to cut a sheet of aerosol generating material as it is conveyed between the first and second cutting elements. The apparatus further includes a housing configured to support the first cutting element relative to the second cutting element. The housing includes an anti-backlash gear coupled to the first cutting element. The housing is adjustable to move the first cutting element relative to the second cutting element to set a new pre-defined distance between the central axes of the first and second cutting elements. The present invention also relates to a method of adjusting an apparatus for cutting a sheet of aerosol generating material.

### RELATED APPLICATIONS

The present application is a National Phase entry of PCT Application No. PCT/GB2023/052742 filed Oct. 20, 2023, which claims priority to GB Application No. 2215642.6 filed Oct. 21, 2022, each of which is hereby incorporated by reference in their entirety.

### TECHNICAL FIELD

The present invention relates to an apparatus for cutting a sheet of aerosol generating material. The present invention also relates to a method of adjusting the apparatus.

### BACKGROUND OF THE INVENTION

It is known to provide an apparatus for cutting a sheet of aerosol generating material. Known apparatus for cutting sheet material have cutting knives that after a certain amount of use are no longer able to provide the quality of cut that is required. Replacing the cutting knives can be expensive and time consuming.

### SUMMARY OF THE INVENTION

According to an embodiment of the present invention, there is provided an apparatus for cutting a sheet of aerosol generating material comprising: a first cutting element comprising a cutting edge and a second cutting element; wherein the first cutting element is rotatable about its central axis and the second cutting element that is rotatable about its central axis; wherein the central axis of the first cutting element and the central axis of the second cutting element are spaced apart by an initial pre-defined distance; wherein the first and second cutting elements are configured to cut a sheet of aerosol generating material as it is conveyed between the first and second cutting elements; a housing configured to support the first cutting element relative to the second cutting element; wherein the housing comprises an anti-backlash gear coupled to the first cutting element; and wherein the housing is adjustable to move the first cutting element relative to the second cutting element to set a new pre-defined distance between the central axes of the first and second cutting elements.

In some embodiments, the housing may be adjustable to move the first cutting element towards the second cutting element such that the new pre-defined distance between the central axes of the first and second cutting elements is less than the initial pre-defined distance.

In some embodiments, the second cutting element may comprise a cutting edge, the cutting edge of the second cutting element being configured to cooperate with the cutting edge of the first cutting element to shear cut a sheer of aerosol generating material as it is conveyed between the first and second cutting elements.

In some embodiments, the housing may further comprise a second anti-backlash gear coupled to the second cutting element.

In some embodiments, the housing may comprise a first housing section and a second housing section, the first housing section being configured to house the first cutting element and the second housing section being configured to house the second cutting element.

In some embodiments, the first housing section may house the first anti-backlash gear coupled to the first cutting element.

In some embodiments, the second housing section may house the second anti-backlash gear coupled to the second cutting element.

In some embodiments, the apparatus may further comprise an adjustment mechanism configured to move the first and second housing sections relative to each other to adjust the distance between the central axes of the first and second cutting elements.

In some embodiments, the adjustment mechanism may be configured to reduce the distance between the central axes of the first and second cutting elements when the diameter of the cutting edge is reduced.

In some embodiments, the adjustment mechanism may comprise at least one shim located between the first and second housing sections, the at least one shim being configured to space the first and second housing sections by the initial pre-defined distance.

In some embodiments, the at least one shim may be removable from between the first and second housing sections so that the first housing section can be moved closer to the second housing section to a new predefined distance with a smaller center distance.

In some embodiments, the adjustment mechanism may comprise a plurality of shims, each of the shims being removable and/or replaceable such that the first housing section can be moved closer to the second housing section to a new predefined distance with a smaller center distance.

In some embodiments, the adjustment mechanism may comprise a threaded bolt, the threaded bolt being configured to move the first housing section closer to the second housing section to a new predefined distance with a smaller center distance when the threaded bolt is rotated in a first direction.

In some embodiments, the threaded bolt may comprise a head that is located on the opposite side of the first housing section to the second housing section, and a shank comprising a threaded section configured to engage with a threaded hole in the second housing section.

In some embodiments, the head of the threaded bolt may be configured to abut the first housing section to cause the first housing section to move towards the second housing section upon rotation of the threaded bolt in the first direction.

In some embodiments, the threaded bolt and the first housing section may comprise mating surfaces configured to prevent linear movement of the first housing section relative to the threaded bolt.

In some embodiments, the threaded bolt may comprise a head that is located between the first and second housing sections, the threaded bolt comprising a first shank extending towards the first housing section and having a first threaded section configured to engage with a first threaded hole therein, the threaded bolt further comprising a second shank extending towards the second housing section and having a second threaded section configured to engage with a second threaded hole therein.

In some embodiments, the adjustment mechanism may comprise a pneumatic ram configured to move the first housing section relative to the second housing section.

In some embodiments, the apparatus may further comprises an alignment shoulder configured to ensure consistent engagement of the first and second cutting elements.

In some embodiments, the housing may further comprise a support frame, wherein the first housing section is movably mounted to the frame in a channel, the frame comprising a supporting means configured to prevent linear movement of the first housing section relative to the threaded bolt.

In some embodiments, the supporting means may be a spring or a counter weight.

In some embodiments, the apparatus may further comprises linear bearings/guide rails extending between the first and second housing sections.

In some embodiments, the housing may be adjustable to move the first cutting element relative to the second cutting element to set a new pre-defined distance between the central axes of the first and second cutting elements after the cutting edge has been reground.

According to another aspect of the present invention, there is provided a method of adjusting the apparatus of claim 1 comprising: re-grinding the cutting edge of the first cutting element; and adjusting the housing to move the first cutting element towards the second cutting element to set a new pre-defined distance.

In some embodiments, the apparatus may further comprise a cutting edge on the second cutting element, and the method may further comprises regrinding the cutting edge of the second cutting element.

In some embodiments, adjusting the housing to move the first cutting element towards the second cutting element to set a new pre-defined distance may comprise removing at least one shim from between the first and second housing sections.

In some embodiments, adjusting the housing to move the first cutting element towards the second cutting element to set a new pre-defined distance may comprise rotating a threaded bolt in a first direction.

In some embodiments, adjusting the housing to move the first cutting element towards the second cutting element to set a new pre-defined distance may comprise actuating a pneumatic ram.

In some embodiments, the method may further comprise adjusting the housing to move the first cutting element away from the second cutting element to remove the cutting elements for grinding.

In some embodiments, the method may further comprise adjusting the housing to move the first cutting element away from the second cutting element to replace the cutting elements and/or anti-backlash gears.

### BRIEF DESCRIPTION OF THE DRAWINGS

So that the invention may be more fully understood, embodiments of the present invention will now be described, by way of example only, with reference to the accompanying drawings, in which:

FIG. 1 shows a generic view of an embodiment of an apparatus for cutting a sheet of aerosol-generating material;

FIG. 2 shows a top view of a sheet of aerosol-generating material as it passes through the apparatus of FIG. 1;

FIGS. 3a to 3c show a side view of an embodiment of the apparatus of FIG. 1 comprising an embodiment of an adjustment mechanism;

FIGS. 4a to 4c show a side view of an embodiment of the apparatus of FIG. 1 comprising an embodiment of an adjustment mechanism;

FIGS. 5a to 5c show a side view of an embodiment of the apparatus of FIG. 1 comprising an embodiment of an adjustment mechanism;

FIG. 6 shows a side view of an embodiment of the apparatus of FIG. 1 comprising an embodiment of an adjustment mechanism;

FIG. 7 shows a side view of an embodiment of the apparatus of FIG. 1 comprising an embodiment of an adjustment mechanism; and

FIG. 8 shows an embodiment of an alignment shoulder of the apparatus of FIG. 7.

### DETAILED DESCRIPTION

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material); and
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo, and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper, or a cigarette paper.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c. v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel. In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

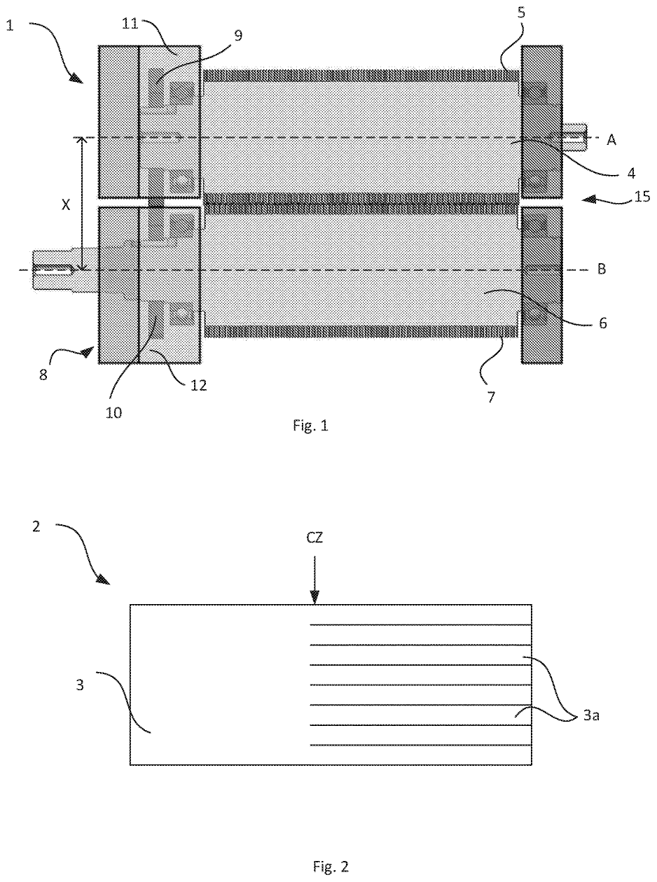

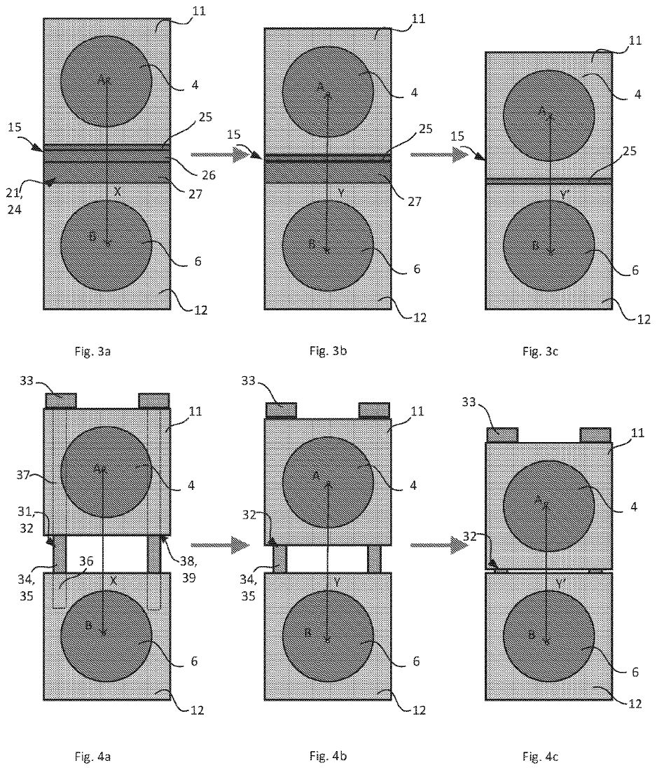

Referring now to FIG. 1, there is shown an apparatus 1 for cutting a sheet 2 of aerosol generating material 3, shown in FIG. 2. The apparatus 1 may cut the sheet 2 of aerosol-generating material 3 in to a plurality of elongate strips 3a or a plurality of partially separated elongate strips (not shown). The apparatus 1 comprises a first cutting element 4 comprising a cutting edge 5 and a second cutting element 6. The first cutting element 4 is rotatable about its central axis A and the second cutting element 6 is rotatable about its central axis B.

Referring briefly to FIG. 2, the sheet 2 of aerosol-generating material 3 is shown schematically at a point where it passes between the first cutting element 4 and second cutting element 6 from left to right. Thus, the sheet 2 of aerosol-generating material 3 on the left of the Figure is moving towards the right and approaching the cutting zone CZ of the apparatus 1. When the sheet 2 of aerosol-generating material 3 passes between the first and second cutting elements 4, 6, the sheet 2 of aerosol-generating material 3 is cut by at least the cutting edge 5 of the first cutting element 4. It will be appreciated that the apparatus 1 may comprise a plurality of first cutting elements 4, and optionally, second cutting elements 6, such that the apparatus 1 comprises a plurality of cutting edges 5 configured to cut the sheet 2 of aerosol-generating material 3 into a plurality of elongate strips 3a, as shown on the right of the Figure downstream of the cutting zone CZ.

Referring back to FIG. 1, the central axis A of the first cutting element 4 and the central axis B of the second cutting element 6 are spaced apart by an initial pre-defined distance X. The initial pre-defined distance X may also be defined as the center distance.

The first cutting element 4 and the second cutting element 6 are configured to cut a sheet 2 of aerosol generating material 3 as the sheet 2 of aerosol generating material 3 is conveyed between the first cutting element 4 and the second cutting element 6.

The apparatus 1 further comprises a housing 8. The housing 8 is configured to support the first cutting element relative to the second cutting element 6. The housing 8 comprises an anti-backlash gear 9. The anti-backlash gear 9 is coupled to the first cutting element 4.

An anti-backlash gear is a mechanism that is configured to reduce, if not eliminate the loss of motion caused by gaps, or clearance, between the teeth of meshed gears. For example, a gear may be driven through a given angular distance before its teeth contact the teeth of the gear with which it is meshed. Thus, an input to rotate a gear through 90 degrees may result in a gear being rotated through less than 90 degrees due to the gaps between teeth. Therefore, the anti-backlash gear 9 is configured to provide highly accurate rotation of the first cutting element 4 relative to the second cutting element 6 to ensure the accurate cutting of the pattern in the sheet of aerosol generating material.

The anti-backlash gear 9 may comprise a first gear (not shown) that is rigidly fixed to an axel in order to drive or be driven by the axel. The anti-backlash gear 9 may comprise a second gear (not shown) that can freely rotate relative to the first gear. The first gear may comprise a central hub (not shown) on which the second gear may be mounted via a central aperture (not shown), i.e. a bushing.

The first gear may comprise an arcuate aperture not shown). The second gear may comprise a tab (not shown) configured to be located in the arcuate aperture. A biasing member (not shown), such as a spring, may be located between an end wall (not shown) of the arcuate aperture and the tab. The biasing member may be configured to bias the tab away from the end wall of the arcuate aperture to ensure that the teeth of the first and second gears are always in contact with the teeth of the gear engaged by the anti-backlash gear. In this way, momentum or motion losses in the gear system are reduced, if not eliminated.

The housing 8 is adjustable to move the first cutting element 4 relative to the second cutting element 6 to set a new pre-defined distance Y, or new central distance, between the central axis A of the first cutting element 4 and the central axis B of the second cutting element 6.

In some embodiments, the housing 8 may be adjustable to move the first cutting element 4 towards the second cutting element 6 such that the new pre-defined distance Y between the central axis A of the first cutting element 4 and the central axis B of the second cutting element 6 is less than the initial pre-defined distance X.

Thus, in an embodiment that performs a crush type cut, the first cutting element 4 may be a cutting drum with cutting knives (edges) and the second cutting element 6 may be an anvil drum, where the first cutting element 4 performs a crush cut against the surface of second cutting element 6. In such an embodiment, after the cutting edge 5 of the first cutting element 4 is worn down and/or re-ground, the first cutting element 4 may be moved towards the second cutting element 6 to compensate for the regrinding process, as will be explained in more detail hereinafter, without having to move or replace a drive gear assembly used for rotating the first and second cutting elements 4, 6.

In some embodiments, the second cutting element 6 may comprise a cutting edge 7. The cutting edge 7 of the second cutting element 6 may be configured to cooperate with the cutting edge of the first cutting element to shear cut a sheet 2 of aerosol-generating material 3 as the sheet 2 of aerosol-generating material 3 is conveyed between the first cutting element 4 and the second cutting element 6.

Thus, the housing 8 may further comprise a second anti-backlash gear 10. The second anti-backlash gear 10 may be coupled to the second cutting element 6. Thus, in an embodiment that performs a shear type cut, the first cutting element 4 may be a cutting drum with cutting knives (edges) and the second cutting element 6 may be a cutting drum with cutting knives (edges), where the first and second cutting elements 4, 6 perform a shearing cut through a sheet 2 of aerosol-generating material 3 where they overlap and interlaces as they rotate.

In such an embodiment, after the cutting edge 5 of the first cutting element 4 and the cutting edge 7 of the second cutting element 6 are worn down and/or reground, the first cutting element 4 may be moved towards the second cutting element 6 to compensate for the regrinding process. Also, the second cutting element 6 may be moved towards the first cutting element 4 to compensate for the regrinding process.

That is, in an embodiment where both the first and second cutting elements 4, 6 comprise a cutting edge 5, 7, the second cutting element 6 may be fixed in position and the first cutting element 4 along with the drive gear assembly may be moved towards the second cutting element 6. Alternatively, the drive gear assembly may be fixed in position and the first cutting element 4 and thereto coupled anti-backlash gear 9 may be moved towards the second cutting element 6, whilst the second cutting element 6 and thereto coupled anti-backlash gear 10 may be moved towards the first cutting element 4.

The housing 8 may be a split housing. That is, the housing 8 may comprise a first housing section 11 and a second housing section 12. The first housing section 11 may be configured to house the anti-backlash gear 9 that is coupled to the first cutting element 4. The housing 8 may also at least partially house the first cutting element 4. However, the cutting edge 5 of the first cutting element 4 may protrude from the first housing section 11 on the side of the first housing section 11 that faces the second housing section 12. The second housing section 12 may be configured to house the second anti-backlash gear 10 that is coupled to the second cutting element 6. However, the cutting edge 7 of the second cutting element 6 may protrude from the second housing section 12 on the side of the second housing section 12 that faces the first housing section 11. The first and second cutting elements 4, 6 may protrude from the first and second housing sections 11, 12, respectively, in order to cooperate to provide the crush or shear cut.

Thus, the present invention enables the first and second cutting elements 4, 6 of the apparatus 1 to be moved closer together to account for a reduction in the radius of a cutting element 5. For example, a cutting element 5 may become worn down over time. This may reduce the radius of the cutting element 5 and different sections of the circumference may be more or less affected than others. Such wear can lead to reduced and/or inconsistent cutting performance of the cutting edges of the apparatus.

To provide a more consistent cutting edge, it is possible to regrind the cutting edge of the cutting element(s). However, during the regrinding process, a small amount of material will be lost from the diameter of the cutting edge. This reduction in the diameter of the cutting edge may provide more consistent cutting performance but can lead to a reduced cutting performance as the cutting edge moves further from the object to be cut, which in this case a sheet of aerosol-generating material. Thus, a sheet of aerosol-generating material that is supposed to be cut fully through its thickness dimension may only be partially cut or a partial cut through the thickness of a sheet of aerosol generating material may not be large enough for the intended purpose.

To overcome this problem, the first and second cutting elements may be moved closer together. When using a standard gear driven assembly, the reduction in the center distance between the first and second cutting elements will lead to the gears of the assembly not meshing together correctly. Thus, a new set of gears would be required for after each regrinding process, which would prove to be complex, costly, and time consuming.

However, the present invention uses an anti-backlash gear which allows for the reduction of a center distance without requiring the gears of the gear assembly to be changed each time the cutting elements are reground. As an example, to be set out in more detail hereinafter, the anti-backlash gear may be capable of allowing up to 1.5 mm of reduction in center distance without requiring the gear assembly to be changed.

This equates to only 7 sets of gear assemblies being required to cover a 10 mm center distance change which would allow for roughly 50 regrinds compared to 50 different gear assemblies for 50 regrinds when using a standard gear assembly.

The apparatus 1 may further comprise an adjustment mechanism 21, various examples of which are shown in the following figures. The adjustment mechanism 21 may be configured to move the first housing section 11 relative to the second housing section 12 to adjust the distance between the central axis A of the first housing section 11 and the central axis B of the second housing section 12. In some embodiment, the adjustment mechanism 21 is configured to reduce the distance between the central axes A, B of the first and second cutting elements 4, 6 when the diameter of the cutting edge 5, 7 is reduced. The adjustment mechanism 21 may be configured to maintain a gap 15 between the first housing section 11 and the second housing section 12 during most, if not all, of the cutting process carried out by the apparatus 1. It will be appreciated that in circumstances where the radius of the cutting edge 5, 7 is sufficiently small that the adjustment mechanism 21 may be configured to close the gap 15 such that the first and second housing sections 11, 12 are in contact.

Referring to FIGS. 3a to 3c, a schematic side view of the apparatus 1 comprising a first embodiment of the adjustment mechanism 21 is shown. As previously described, the apparatus 1 comprises the housing 8 formed from the first housing section 11 and the second housing section 12. The first housing section 11 houses the first cutting element 4 and the first anti-backlash gear 9, shown in FIG. 1, which is coupled to the first cutting element 4. The second housing section 12 houses the second cutting element 6 and the second anti-backlash gear 10, shown in FIG. 1, which is coupled to the second cutting element 6.

In the present embodiment, the first housing section 11 is located above the second housing section 12. The first housing section 11 is located above the second housing section 12 such that the first housing section 11 is spaced from the second housing section 12 by a gap 15. The gap 15 between the first and second housing sections 11, 12 is the area of the apparatus 1 into which a sheet 2 of aerosol generating material 3 is fed and where the first and second cutting edges 5, 7, shown in FIG. 1, cooperate to crush or shear cut the sheet 2 of aerosol generating material 3.

The gap 15 is maintained by the adjustment mechanism 21. In the present embodiment, the adjustment mechanism 21 comprises at least one shim 24. The at least one shim 24 may be located between the first housing section 11 and second housing section 12. The at least one shim 24 may be configured to space the first housing section 11 from the second housing section 12 by the pre-defined distance X. Furthermore, the at least one shim 24 may be removeable from between the first housing section 11 and the second housing section 12 so that the first housing section 11 can be moved closed to the second housing section 12 to a new pre-defined distance Y. The new pre-defined distance Y may have a smaller center distance than the initial pre-defined distance X.

The at least one shim 24 may be a block configured to withstand the weight of the first housing section 11 without substantial deformation. The block may be, for example, but not limited to, substantially rectangular in cross-section, although it will be understood that blocks of other cross-section may be used. Furthermore, although the at least one shim 24 is shown as a single piece, the at least one shim 24 may be formed by a plurality of individual pieces. That is, instead of having at least one shim 24 that is formed by a rectangular frame shaped block, i.e. hollow cuboid, that extends along the periphery of the at least one shim 24 may be formed by four square shaped pieces that are located at the corners of the housings 11, 12.

In some embodiments, the adjustment mechanism 21 may comprise a plurality of shims 24. Each of the shims 24 may be removable and/or replaceable such that the first housing section 11 can be moved closer to the second housing section 12 to a new pre-defined distance Y. The new pre-defined distance Y may have a smaller center distance than the initial pre-defined distance X

For example, in FIG. 3a, the adjustment mechanism 21 comprises a first shim 25, a second shim 26, and a third shim 27. The first shim 25 is in contact with the first housing section 11. Therefore, the first shim 25 is located adjacent to and underneath the first housing section 11. The second shim 26 is in contact with the first shim 25. Therefore, the second shim 26 is located adjacent to and underneath the first shim 25. The third shim 27 is in contact with the second shim 26. Therefore, the third shim 27 is located adjacent to and underneath the second shim 26. In addition, the third shim 27 is in contact with the second housing section 12. Therefore, the third shim 27 is located adjacent to and above the second housing section 12.

In the presently described example, each of the first, second, and third shims 25, 26, 27 have a different thickness. The thickness of the each of the first, second, and third shims 25, 26, 27 may be measured in the direction of the center distance. In this example, the first shim 25 has the smallest thickness dimension and the third shim 27 has the largest thickness dimension. However, it will be appreciated that in other embodiments, each of the shims 25, 26, 27 may have the same thickness.

In FIG. 3a, the apparatus 1 comprises the first shim 25, the second shim 26, and the third shim 27 located in the gap 15 between the first housing section 11 and the second housing section 12. Thus, the initial pre-defined distance is set as the combined thickness of the first, second, and third shims 25, 26, 27.

Once the apparatus 1 has performed a cutting operation for a period of time, the cutting edge 5 of the first cutting element 4 and/or the cutting edge 7 of the second cutting element 6 may become worn and require re-grinding. After the regrinding process, the radius of the cutting elements 4, 6 will be smaller than before and so may be unable to provide the same quality cut. Thus, the center distance between the central axes A, B of the first and second cutting elements 4, 6 will need to be reduce to ensure that the first and second cutting element 4, 6 cooperate sufficiently to provide the required cut.

In the present embodiment, this achieved through use of the adjustment mechanism 21. Referring to FIG. 3b, it can be seen that the second shim 26 has been removed from between the first shim 25 and the third shim 27. Therefore, the third shim 27 is located adjacent to and underneath the first shim 25. That is, the first shim 25 is in contact with the third shim 27. Thus, the center distance between the first cutting element 4 and the second cutting element 6 has been reduced to a new-predefined distance Y. The new pre-defined distance Y shown in FIG. 3b is smaller than the initial pre-defined distance X shown in FIG. 3a.

Once the apparatus has performed further cutting operations for another period of time, the cutting edge 5 of the first cutting element 4 and/or the cutting edge 7 of the second cutting element 6 may become worn and require re-grinding again. After the regrinding process, the radius of the cutting elements 4, 6 will be smaller than before and so may be unable to provide the same quality cut. Thus, the center distance between the central axes A, B of the first and second cutting elements 4, 6 will need to be reduce to ensure that the first and second cutting element 4, 6 cooperate sufficiently to provide the required cut.

Referring briefly to FIG. 3c, it can be seen that this is achieved by the removal of another of the shims from between the first and second housing sections 11, 12. In the present example, it can be seen that the third shim 27 has been removed from between the first shim 25 and the second housing section 12. Therefore, the first shim 25 is located adjacent to and underneath the first housing section 11 and adjacent to and above the second housing section 12. That is, the first shim 25 is in contact with the first and second housing sections 11, 12. Thus, the center distance between the first cutting element 4 and the second cutting element 6 has been reduced to a new-predefined distance Y′. The new pre-defined distance Y′ shown in FIG. 3c is smaller than the new pre-defined distance Y shown in FIG. 3 b and the initial pre-defined distance X shown in FIG. 3 a.

It will be appreciated that the adjustment mechanism 21 may comprise more shims 24 that explicitly described in the above example. Furthermore, it will be appreciated that the shims 24 may be removed in a different order to that described above and that different combinations of shims 24 may be used to achieve different center distances to adjust the center distance correctly for the radius of the first and second cutting elements 4, 6 depending on the amount of grinding that has taken place. For example, after the first regrinding process, the first shim 25 may be removed and after the second regrinding process, the second shim 26 may be replaced with the first shim 25, etc.

Referring now to FIGS. 4a to 4c, another embodiment of an adjustment mechanism 31 is shown. In the present embodiment, the adjustment mechanism 31 comprises a threaded bolt 32. The threaded bolt 32 may be configured to move the first housing section 11 closer to the second housing section 12 from an initial pre-defined distance X to a new pre-defined distance Y with a smaller center distance when the threaded bolt 32 is rotated in a first direction.

The threaded bolt 32 may comprise a head 33 and a shank 34. The shank 34 may extend from the head 33 of the threaded bolt 32. The head 33 of the threaded bolt 32 may have a larger diameter than the shank 34 of the threaded bolt 32. The head 33 of the threaded bolt 32 may be located on the opposite side of the first housing section 11 to the second housing section 12. The shank 34 may comprise a threaded section 35. The threaded section 35 may be configured to engage with a threaded hole 36 in the second housing section 12.

In the present embodiment, the first housing section 11 may comprise a through hole 37. The through hole 37 may be configured to receive the shank 33 of the threaded bolt 32 and allow the shank 33 to pass through the first housing section 11 and into the threaded hole 36 in the second housing section 12. The through hole 37 in the first housing section 11 may be configured to have a smaller diameter than the head 33 of the threaded bolt 32 in order to prevent the threaded bolt 32 falling through the through hole 37 of the first housing section 11. Thus, the head 33 of the threaded bolt 32 may be configured to abut the first housing section 11. That is, the head 33 of the threaded bolt 32 may be configured to abut an upward facing surface 13 of the first housing section 11. The head 33 of the threaded bolt 32 may be configured to abut the first housing section 11 to cause the first housing section 11 to move towards the second housing section 12 upon rotation of the threaded bolt 32 in the first direction.

In the present embodiment, the threaded bolt 32 and the first housing section 11 may comprise complementary mating surfaces 38, 39 configured to prevent linear movement of the first housing section 11 relative to the threaded bolt 32.

The threaded bolt 32 and associated holes 36, 37 may be located proximate to a corner of the first and second housing sections 11, 12. The holes 36, 37 may be positioned so that they align on the same vertical axis to allow the threaded bolt 32 to fit into both holes 36, 37. When the threaded bolt 32 and associated holes 36, 37 are said to be located proximate to a corner of the first and second housing sections 11, 12, it is meant that they may be located on the upstream and/or downstream side of the first and second housing sections 11, 12 in relation to the direction of movement of the sheet 2 of aerosol-generating material 3, as shown in FIGS. 4a to 4c, and at an end of the first and second housing sections 11, 12 in a direction perpendicular to the direction of movement of the sheet 2 of aerosol-generating material 3 through the apparatus 1. In this way, the threaded bolt 32 does not impede the motion of the sheet 2 of aerosol-generating material 3 through the apparatus 1.

As shown in FIGS. 4a to 4c, the adjustment mechanism 31 may comprise more than one threaded bolt 32. Each threaded bolt 32 may have its own associated threaded hole 36 in the second housing section 12 and through hole 37 in the first housing section 11. It will be appreciated that in some embodiments, only a single threaded bolt 32 and associated holes 36, 37 may be used and that the apparatus 1 may further comprise a linear bearing and/or guide rail, not shown in FIG. 4, extending between the first and second housing sections 11, 12 in place of the other illustrated threaded bolt 32.

Thus, after the apparatus 1 has performed a cutting operation for a period of time and after the first and second cutting elements 4, 6 have been re-ground, the first housing section 11 may need to be moved closer to the second housing section 12. Therefore, the head 33 of the threaded bolt 32 is engaged by a tool and rotated in the first direction. Rotation of the head 33 of the threaded bolt 32 causes the shank 34 of the threaded bolt to also rotate. By virtue of the engagement of the threaded section 35 of the shank 34 with the threaded hole 36 in the second housing section 12, the threaded bolt 32 is moved downwards relative to the second housing section 12. As the head 33 of the threaded bolt 32 engages an upward facing surface 13 of the first housing section 11, movement of the threaded bolt 32 in a downward direction causes downward movement of the first housing section 11 relative to the second housing section 12.

This motion causes the center distance between the first cutting element 4 and the second cutting element to reduce from the initial pre-defined distance X to a new pre-defined distance Y, as shown in FIG. 4b. Further rotation of the threaded bolt 32 causes further motion of the first housing section 11 and first cutting element 4 relative to the second housing section 12 and second cutting element 6, as shown in FIG. 4c.

The present embodiment has the advantage that the threaded bolt 32 can be rotated to set the new pre-defined distance Y between the central axes A, B of the first and second cutting elements 4, 6 at any distance, rather than pre-defined distances as with shims. Furthermore, the present embodiment has the advantage that by rotating the threaded bolt 32, the central distance between the central axes A, B of the first and second cutting elements 4, 6 can be changed to change the type of cut being performed.

For example, the apparatus 1 may be set up to perform a cut through the whole of the thickness of the sheet 2 of aerosol-generating material 3 to form a plurality of elongate strips 4, see FIG. 2. However, by rotating the threaded bolt 32 in a direction opposite to the first direction, i.e. a second direction, the central distance can be increased in order for the apparatus 1 to perform a cut through only a part of the thickness of the sheet 2 of aerosol-generating material 3 to form a plurality of partially separated strips (not shown).

In an alternative embodiment, the threaded section 35 of the shank 34 of the threaded bolt 32 may engage with a threaded through hole 37 in the first housing section 11. Thus, the threaded bolt 32 may be supported in a hole in the second housing section 12 and rotation of the threaded bolt 32 may cause the first housing section 11 to be moved downwards towards the second housing section 12 along the threaded bolt 32 without the threaded bolt 32 moving linearly as in the previously described embodiment.

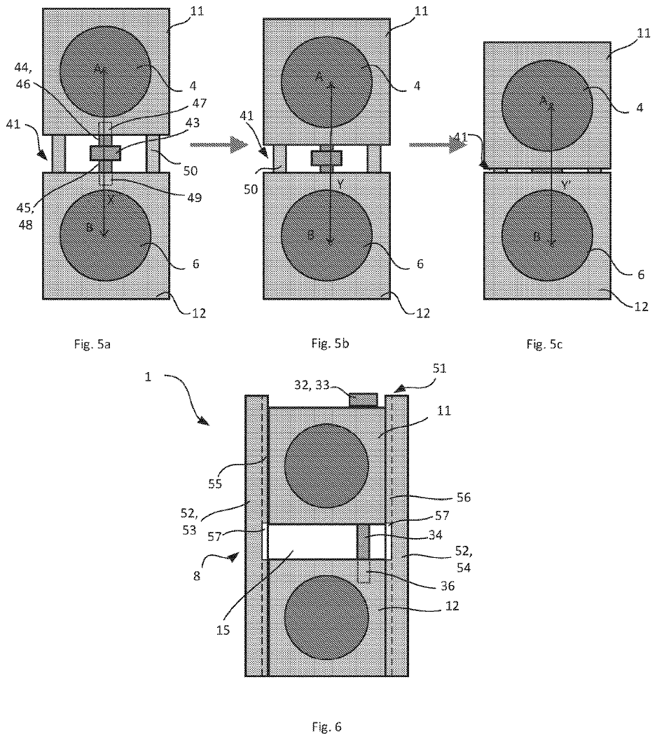

Referring now to FIGS. 5a to 5c, another embodiment of the adjustment mechanism 41 is shown. The adjustment mechanism 41 is similar to the adjustment mechanism 31 described above in relation to FIGS. 4a to 4c, and so a detailed description will be omitted herein. Furthermore, similar features and components will retain their terminology and reference numerals.

In the present embodiment, the adjustment mechanism 41 comprises a threaded bolt 42. The threaded bolt 42 may be configured to move the first housing section 11 closer to the second housing section 12 from an initial pre-defined distance X to a new pre-defined distance Y with a smaller center distance when the threaded bolt 42 is rotated in a first direction.

The threaded bolt 42 may comprise a head 43, a first shank 44, and a second shank 45. In the present embodiment, the head 43 of the threaded bolt 32 may be located between the first housing section 11 and the second housing section 12. The first shank 44 may extend from a first side of the head 43 of the threaded bolt 42. The first shank 44 may extend towards the first housing section 11. The first shank 44 may comprise a first threaded section 46 that is configured to engage with a first threaded hole 47 in the first housing section 11. The second shank 45 may extend from a second side of the head 43 of the threaded bolt 42. The second side of the head 43 may be the opposite side of the head 43 to the first side of the head 43 of the threaded bolt 42. The second shank 45 may extend towards the second housing section 12. The second shank 45 may comprise a second threaded section 48 that is configured to engage with a second threaded hole 49 in the second housing section 12.

The adjustment mechanism 41 may further comprise at least one linear bearing 50 or guide rails. The at least one linear bearing 50 may extend between the first housing section 11 and the second housing section 12. The at least one linear bearing 50 may be configured to keep the first and second housing sections 11, 12 aligned as they are moved towards each other and to maintain the first housing section 11 extending parallel to the second housing section 12.

The present embodiment of the adjustment mechanism 41 functions in a similar way to the adjustment mechanism 31 described above. Therefore, a detailed description of the functioning of the adjustment mechanism 41 shown in FIGS. 5a to 5c will be omitted herein.

It will be understood that rotation of the head 43 of the threaded bolt 42 by a tool (not shown) causes the first and second shanks 44, 45 to rotate. This rotation of the first and second shanks 44, 45 and the engagement of the threaded section 46 of the first shank 44 in the first threaded hole 47 in the first housing section 11 and the engagement of the threaded section 48 of the second shank 45 in the second threaded hole 49 in the second housing section 12 drives the first and second shanks 44, 45 into the first and second housing sections 11, 12, respectively. Thus, the first housing section 11 is moved towards the second housing section 12 and a new pre-defined distance Y is set between the central axes A, B of the first and second cutting elements 4, 6, as shown in FIG. 5b.

The process may be repeated until the first and second housings 11, 12 are as close to each other as possible, as shown in FIG. 5c.

Referring now to FIG. 6, a further embodiment of the adjustment mechanism 51 is shown. The adjustment mechanism 51 is similar to the adjustment mechanism 31 described above in relation to FIGS. 4a to 4c, and so a detailed description thereof will be omitted herein. Furthermore, similar features and components will retain their terminology and reference numerals.

In the present embodiment, the housing 8 of the apparatus 1 may further comprise a support frame 52. The support frame 52 may extend vertically. The first housing section 11 and the second housing section 12 may be mounted to the support frame 52. As shown in FIG. 6, the support frame 52 may comprise first and second frame portions 53 ,54. The first frame portion 53 may be located on the upstream side of the first and second housing sections 11, 12 and the second frame portion 54 may be located on the downstream side of the first and second housing sections 11, 12.

Furthermore, the support frame 52 may comprise a channel 55, 56. The channel 55, 56 may extend vertically along the length of the support frame 52. More specifically, the first frame portion 53 may comprise a first channel 55 and the second frame portion 54 may comprise a second channel 56.

The first housing section 11 may be movably mounted on the support frame 52. More specifically, the first housing section 11 may be movably mounted in the channels 55, 56 of the first and second frame portions 53, 54 of the support frame 52. That is, the first housing section 11 may be moved up and down in the channels 55, 56 of the support frame 52.

The present embodiment uses the same adjustment mechanism 51 as described in relation to the embodiment shown in FIGS. 4a to 4c. However, in the present embodiment, the threaded bolt 32 may not have a mating surface with the first housing section 11 that is configured to prevent relative movement between the threaded bolt 32 and the first housing section 11.

Instead, the adjustment mechanism 51 of the present embodiment may comprise a supporting means 57 located within the support frame 52. The supporting means 57 may be configured to prevent linear movement of the first housing section 11 relative to the threaded bolt 32. The supporting means 57 may be, for example, but not limited to, a spring or a counterweight.

Thus, in the present embodiment, the spring or counterweight may urge the first housing section 11 in an upward direction away from the second housing section 12. However, the presence of the head 33 of the threaded bolt 32 abutting an upward facing surface 13 of the first housing section 11 and the engagement of the threaded section 35 of the shank 34 of the threaded bolt 32 in the threaded hole 36 in the second housing section 12 prevents the first housing section 11 from moving away from the second housing section 12 whilst preventing the gap 15 between the first and second housing sections 11, 12 from closing unintentionally.

The apparatus 1 is adjustable in the same way as described above in relation to FIGS. 4a to 4c by the rotation of the threaded bolt 32. Therefore, a detailed description thereof will be omitted herein.

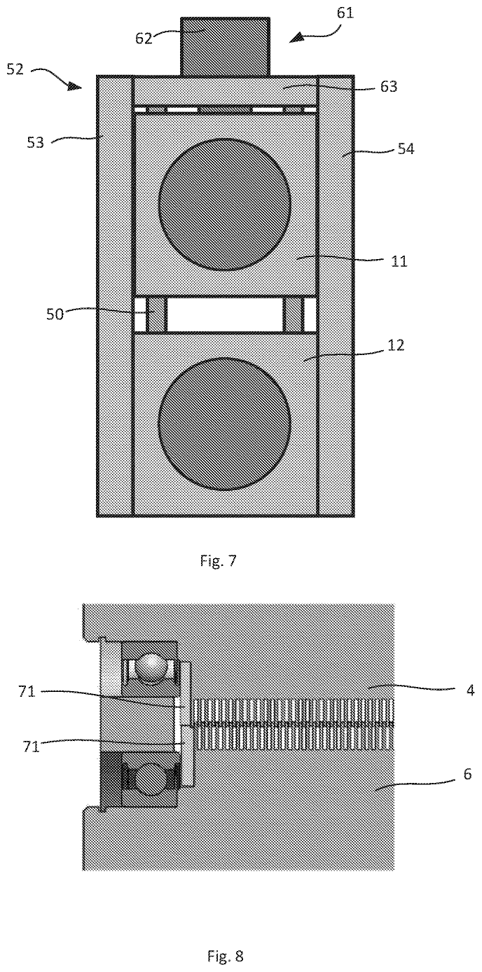

Referring now to FIG. 7, there is shown a further embodiment of the adjustable mechanism 61 of the present invention. The present embodiment is similar to those described above, and so a detailed description herein will be omitted. In the present embodiment, the adjustment mechanism is formed by a ram 62. The ram 62 may be a pneumatic ram or a hydraulic ram. The ram 62 is configured to move the first housing section 11 relative to the second housing section 12.

As shown in FIG. 7, the ram 62 may be located above the first housing section 11 on the support frame 52. In the present embodiment, the support frame 52 may comprise a cross-beam 63 extending between the first and second frame portions 53, 54. Furthermore, the first housing section 11 may be mounted on linear bearings 50 configured to guide the vertical motion of the first housing section 11 under force provide by the ram 62.

Referring briefly to FIG. 8, an alignment shoulder 71 is shown. The alignment shoulder 71 may be located between the first cutting element 4 and the second cutting element 6 of any of the embodiments previously discussed. The alignment shoulder 71 may be configured to ensure consistent engagement and alignment of the first and second cutting elements 4, 6. The alignment shoulder 71 may be re-ground each time the first and second cutting elements 4, 6 are re-ground and the center distance between the central axes A, B of the first and second cutting elements 4, 6 is reset.

Although described above in relation to each of the disclosed embodiments, a method of adjusting the apparatus 1 will now be described. The method of adjusting the apparatus 1 comprises: re-grinding the cutting edge 5 of the first cutting element 4; and adjusting the housing 8 to move the first cutting element 4 from an initial pre-defined distance X towards the second cutting element 6 to set a new pre-defined distance Y.

In some embodiments, the apparatus 1 may further comprise a cutting edge 7 on the second cutting element 6. In such embodiments, the method may further comprise re-grinding the cutting edge 7 of the second cutting element 6.

The step of adjusting the housing 8 to move the first cutting element 4 towards the second cutting element 6 to set a new-predefined distance Y may comprise removing at least one shim 24 from between the first and second housing sections 11, 12.

The step of adjusting the housing 8 to move the first cutting element 4 towards the second cutting element 6 to set a new-predefined distance Y may comprise rotating a threaded bolt 32, 42 in a first direction.

The step of adjusting the housing 8 to move the first cutting element 4 towards the second cutting element 6 to set a new-predefined distance Y may comprise actuating a pneumatic ram.

The method of adjusting the apparatus 1 may further comprise adjusting the housing 8 to move the first cutting element 4 away from the second cutting element 6 to remove the cutting elements 4, 6 for grinding. The method of adjusting the apparatus 1 may also further comprise adjusting the housing 8 to move the first cutting element 4 away from the second cutting element 6 to replace the cutting elements 4, 6and/or anti-backlash gears 9, 10.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An apparatus for cutting a sheet of aerosol generating material comprising:
a first cutting element comprising a cutting edge and a second cutting element;
wherein the first cutting element is rotatable about its central axis and the second cutting element that is rotatable about its central axis;
wherein the central axis of the first cutting element and the central axis of the second cutting element are spaced apart by an initial pre-defined distance;
wherein the first and second cutting elements are configured to cut a sheet of aerosol generating material as it is conveyed between the first and second cutting elements;
a housing configured to support the first cutting element relative to the second cutting element;
wherein the housing comprises an anti-backlash gear coupled to the first cutting element; and
wherein the housing is adjustable to move the first cutting element relative to the second cutting element to set a new pre-defined distance between the central axes of the first and second cutting elements.

2. The apparatus according to claim 1, wherein the housing is adjustable to move the first cutting element towards the second cutting element such that the new pre-defined distance between the central axes of the first and second cutting elements is less than the initial pre-defined distance.

3. The apparatus according to claim 1 wherein the second cutting element comprises a cutting edge, the cutting edge of the second cutting element being configured to cooperate with the cutting edge of the first cutting element to shear cut a sheer of aerosol generating material as it is conveyed between the first and second cutting elements.

4. The apparatus according to claim 3, wherein the housing further comprises a second anti-backlash gear coupled to the second cutting element.

5. The apparatus according to claim 4, wherein the housing comprises a first housing section and a second housing section, the first housing section being configured to house the first cutting element and the second housing section being configured to house the second cutting element.

6. The apparatus according to claim 5, wherein the first housing section houses the first anti-backlash gear coupled to the first cutting element.

7. The apparatus according to claim 6, wherein the second housing section houses the second anti-backlash gear coupled to the second cutting element.

8. The apparatus according to claim 5, further comprising an adjustment mechanism configured to move the first and second housing sections relative to each other to adjust the distance between the central axes of the first and second cutting elements.

9. The apparatus according to claim 8, wherein the adjustment mechanism is configured to reduce the distance between the central axes of the first and second cutting elements when the diameter of the cutting edge is reduced.

10. The apparatus according to claim 8, wherein the adjustment mechanism comprises at least one shim located between the first and second housing sections, the at least one shim being configured to space the first and second housing sections by the initial pre-defined distance.

11. The apparatus according to claim 10, wherein the at least one shim is removable from between the first and second housing sections so that the first housing section can be moved closer to the second housing section to a new predefined distance with a smaller centre distance.

12. The apparatus according to claim 11, wherein the adjustment mechanism comprises a plurality of shims, each of the shims being removable and/or replaceable such that the first housing section can be moved closer to the second housing section to a new predefined distance with a smaller centre distance.

13. The apparatus according to claim 8, wherein the adjustment mechanism comprises a threaded bolt, the threaded bolt being configured to move the first housing section closer to the second housing section to a new predefined distance with a smaller centre distance when the threaded bolt is rotated in a first direction.

14. The apparatus according to claim 13, wherein the threaded bolt comprises a head that is located on the opposite side of the first housing section to the second housing section, and a shank comprising a threaded section configured to engage with a threaded hole in the second housing section.

15. The apparatus according to claim 14, wherein the head of the threaded bolt is configured to abut the first housing section to cause the first housing section to move towards the second housing section upon rotation of the threaded bolt in the first direction.

16. The apparatus according to claim 14, wherein threaded bolt and the first housing section comprise mating surfaces configured to prevent linear movement of the first housing section relative to the threaded bolt.

17. The apparatus according to claim 13, wherein the threaded bolt comprises head that is located between the first and second housing sections, the threaded bolt comprising a first shank extending towards the first housing section and having a first threaded section configured to engage with a first threaded hole therein, the threaded bolt further comprising a second shank extending towards the second housing section and having a second threaded section configured to engage with a second threaded hole therein.

18. The apparatus according to claim 8, wherein the adjustment mechanism comprises a pneumatic ram configured to move the first housing section relative to the second housing section.

19. The apparatus according to claim 18, further comprising an alignment shoulder configured to ensure consistent engagement of the first and second cutting elements.

20. The apparatus according to claim 13, wherein the housing further comprises a support frame, wherein the first housing section is movably mounted to the frame in a channel, the frame comprising a supporting means configured to prevent linear movement of the first housing section relative to the threaded bolt.

21. The apparatus according to claim 20, wherein the supporting means is a spring or a counter weight.

22. The apparatus according to claim 13, further comprising linear bearings/guide rails extending between the first and second housing sections.

23. The apparatus according to claim 1, wherein the housing is adjustable to move the first cutting element relative to the second cutting element to set a new pre-defined distance between the central axes of the first and second cutting elements after the cutting edge has been reground.

24. A method of adjusting the apparatus of claim 1 comprising:
re-grinding the cutting edge of the first cutting element; and
adjusting the housing to move the first cutting element towards the second cutting element to set a new pre-defined distance.

25. The method according to claim 24,
wherein the apparatus further comprises a cutting edge on the second cutting element, the method further comprising regrinding the cutting edge of the second cutting element.
